(19) United States
(12) Patent Application Publication
(10) Pub. No.: US 2014/0195972 A1
(43) Pub. Date: Jul. 10, 2014

(54) METHOD AND APPARATUS FOR MANAGING PROGRAMS OR ICONS

(71) Applicant: Electronics and Telecommunications Research Institute, Daejeon (KR)

(72) Inventors: Seung-Hwan LEE, Daejeon (KR); Junho LEE, Daejeon (KR)

(73) Assignee: Electronics and Telecommunications Research Institute, Daejeon (KR)

(21) Appl. No.: 14/148,195

(22) Filed: Jan. 6, 2014

(30) Foreign Application Priority Data
Jan. 7, 2013 (KR) 10-2013-0001657
Dec. 20, 2013 (KR) 10-2013-0160509

(51) Int. Cl. G06F 3/0481; G06F 3/0484; G06F 3/0488

(52) U.S. Cl. CPC G06F 3/04817; G06F 3/0488; G06F 3/04842
USPC 715/811; 715/835

(57) ABSTRACT

A terminal is provided. The terminal includes a memory, and a processor for managing icons of programs installed in the memory. The processor determines a criterion for icon arrangement, arranges the icons according to the criterion for icon arrangement, and displays all or some of the arranged icons on a screen. The criterion for icon arrangement comprises at least one of most recently/frequently used, time, place, pattern of program use, and category.

### CROSS-REFERENCE TO RELATED APPLICATION

This application claims priority to and the benefit of Korean Patent Application Nos. 10-2013-0001657, and 10-2013-0160509 respectively filed in the Korean Intellectual Property Office on Jan. 7, 2013, and Dec. 20, 2013, the entire contents of which are incorporated herein by reference.

### BACKGROUND OF THE INVENTION

(a) Field of the Invention

The present invention relates to a program user interfaced technology for a terminal. More particularly, the present invention relates to a method and apparatus for managing programs installed in a terminal or program icons.

(b) Description of the Related Art

Many programs are installed and used in a terminal (e.g., a portable computer) as required by a user. Such portable computers have input device limitations because of their small size and design limitations. Due to these limitations, portable computers have turn into even simpler systems that run a program by clicking (or touching) one of an extensive arrangement of icons. Unless the user does not identify the exact location of the icon of a program they want to run, with numerous icons scattered across the screen, the user will have to spend quite a bit of time finding and running the program according to circumstances.

Taking smartphones as a typical example of portable computers, numerous applications are appearing every day as the application market is growing fast. Naturally, this encourages smartphone users to install and use a myriad number of applications on their smartphones. As the number of applications installed on one smartphone increases, the users want their applications to be managed and used efficiently. However, the prior art technologies regarding the management and arrangement of applications are limited to organizing applications in folders on a smartphone or after interfacing with a computer.

### SUMMARY OF THE INVENTION

The present invention has been made in an effort to provide a user interface method and apparatus which allow a portable computer user to easily access a desired program and use it according to circumstances.

An exemplary embodiment of the present invention provides a method for managing icons of programs installed in a terminal. The method for managing icons on a terminal includes: determining a criterion for icon arrangement; arranging the icons according to the criterion for icon arrangement; and displaying all or some of the arranged icons on a screen. The criterion for icon arrangement includes at least one of most recently/frequently used, time, place, pattern of program use, and category.

The arranging may include: when arranging the icons by most frequently used, calculating how frequently each program is used based on usage statistics of the programs used for a statistical period; and arranging the icons in order of most frequently used programs.

The arranging may include: when arranging the icons by time, determining if a current time is within a first time range; whether so, calculating how frequently each program is used based on usage statistics of the programs used within the first time range for a statistical period; and arranging the icons in order of most frequently used programs.

The arranging may include: when arranging the icons by time, determining whether a current day is a first day; if so, calculating how frequently each program is used based on usage statistics of the programs used on first days for a statistical period; and arranging the icons in order of most frequently used programs.

The arranging may include: when arranging the icons by time, determining whether a current date is a first date; if so, calculating how frequently each program is used based on usage statistics of the programs used on first dates for a statistical period; and arranging the icons in order of most frequently used programs.

The arranging may include: when arranging the icons by place, determining whether a current location is a first place; if so, calculating how frequently each program is used based on usage statistics of the programs used at the first place for a statistical period; and arranging the icons in order of most frequently used programs.

The arranging may include: when arranging the icons according to the pattern of program use, determining whether a first program is currently running; if so, calculating how frequently each program is used based on usage statistics of programs running after the first program is run, for a statistical period; and arranging the icons in order of most frequently used programs.

The arranging may include: when arranging the icons by category, identifying category values for the programs; and arranging the icons by categories corresponding to the program category values.

The method for managing icons on a terminal may further include, before the determining, changing the criterion for icon arrangement to a first arrangement criterion of a plurality of arrangement criteria. The first arrangement criterion may comprise at least one of the above-described criteria, which are most recently/frequently used, time, place, pattern of program use, and category.

The changing may include: displaying a first icon corresponding to a first program for changing the criterion for icon arrangement, on the screen; when there is user input on the first icon, running the first program and displaying the plurality of arrangement criteria on the screen; and when there is user input on the first arrangement criterion, changing the criterion for icon arrangement to the first arrangement criterion.

The changing may include: when there is user input of sliding the screen from a first point to a second point on the screen, displaying a first page for changing the criterion for icon arrangement on the screen; and when there is user input of sliding a first screen from a third point to a fourth point, with the first screen displaying the first page, changing the criterion for icon arrangement to the first arrangement criterion.

The changing may include: determining whether at least either one of the current time and the current location corresponds to change settings information; and if so, changing the criterion for icon arrangement to the first arrangement criterion according to the change settings information.

The displaying may include: allocating a first portion of the screen as a space for displaying the arranged icons; and displaying all or some of the icons arranged in the first portion.

The displaying in the first portion may include adjusting the size of first icons displayed in the first portion depending on the number of first icons.

The method for managing icons on a terminal may further include: when there is user input of sliding a second screen from a fifth point to a sixth point, with the second screen displaying all or some of the icons arranged according to the first arrangement criterion, changing the criterion for icon arrangement to a second arrangement criterion of the plurality of arrangement criteria.

Another embodiment of the present invention provides a terminal. The terminal includes a memory, and a processor for managing icons of programs installed in the memory. The processor determines a criterion for icon arrangement, arranges the icons according to the criterion for icon arrangement, and displays all or some of the arranged icons on a screen. The criterion for icon arrangement may comprise at least one of most recently/frequently used, time, place, pattern of program use, and category.

Yet another embodiment of the present invention provides a terminal. The terminal includes a memory, and a processor for managing icons of programs installed in the memory. The processor determines whether there is a first program that have been used less than a threshold for a statistical period among the programs.

The processor determines whether the first program is deletable based on delete settings information set by the user, and if so, deletes the first program.

The processor stores a first icon corresponding to the first program in a temporary storage box, and deletes the first program when no instruction to delete the first icon from the temporary storage box is input from the user for a threshold period of time.

### BRIEF DESCRIPTION OF THE DRAWINGS

FIG. 1 is a view showing a method for changing the criterion for arrangement of icons according to an exemplary embodiment of the present invention.

FIG. 2 is a view showing a method for changing the criterion for icon arrangement according to another exemplary embodiment of the present invention.

FIG. 3 is a view showing a method for changing the criterion for icon arrangement according to yet another exemplary embodiment of the present invention.

FIG. 4 is a view showing an icon display method according to an exemplary embodiment of the present invention.

FIG. 5 is a view showing an icon display method according to another exemplary embodiment of the present invention.

FIG. 6 is a view showing an icon display method according to yet another exemplary embodiment of the present invention.

FIG. 7 is a view showing an icon display method according to a further exemplary embodiment of the present invention.

FIG. 8 is a view showing the configuration of a portable computer according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The present invention involves a technology for allowing a portable computer user to easily access a desired program and use it according to circumstances. The term portable computer refers to a computer such as a smartphone, a tablet PC, a laptop, etc., where programs (including applications) can be installed and accessed through program icons.

Hereinafter, 1) a criterion for icon arrangement, 2) a method for changing the criterion for icon arrangement, 3) an icon display method, and 4) a method of managing the capacity of the portable computer according to an exemplary embodiment of the present invention will be described in detail. The method of managing the portable computer's capacity includes: 1) a method of notification of unnecessary programs; 2) a display method using a temporary storage box; or 3) an automatic program deletion method.

### 1. Criterion for Program Icon Arrangement

The criterion for icon arrangement includes most recently/frequently used, time, place, pattern of program use, or category. Default values exist for all these criteria, and a user can configure the settings for each arrangement criterion in the settings window on a portable computer according to the user's needs.

When arranging the icons by most recently/frequently used, the portable computer arranges the icons in order of programs the user has used most often recently. For example, the portable computer calculates how frequently each program is used based on the usage statistics of the programs used for a first statistical period (e.g., the past month), and arranges the icons in order of most frequently used programs. A default value exists for the first statistical period, and the first statistic period can be changed by the user.

When arranging the icons by time, the portable computer arranges the icons in order of programs the user often uses (or will most likely use) at certain times of the day, on certain days of the week, or on special occasions (or in order of programs the user will most likely use). For example, the portable computer determines if the current time is within a first time range (e.g., 14:00 to 17:00). If so, the portable computer calculates how frequently each program is used based on the usage statistics of the programs used within the first time range for a second statistical period (e.g., the past two months), and arranges the icons in order of most frequently used programs. Moreover, the portable computer determines if the current day is a first day (e.g., Monday). If so, the portable computer calculates how frequently each program is used based on the usage statistics of the programs used on the first days for a third statistical period (e.g., the past three months), and arranges the icons in order of most frequently used programs. Further, the portable computer determines if the current date is a first date (e.g., the user's birthday). If so, the portable computer calculates how frequently each program is used based on the usage statistics of the programs used on the first dates for a fourth statistical period (e.g., the past two years), and arranges the icons in order of most frequently used programs. Also, the portable computer is able to automatically recognize programs the user often uses at specific times of day, on specific days of the week, or on special occasions. Alternatively, the user can manually select programs they often use at specific times of day, on specific days of the week, or on special occasions, and the portable computer is able to arrange the icons according to the programs selected by the user. The portable computer is also able to arrange the icons in conjunction with a scheduling program entered previously by the user. Default values exist for the second to fourth statistical periods, and the second to fourth statistical periods can be changed by the user.

When arranging the icons by place, the portable computer arranges the icons in order of programs the user often uses (or will most likely use) at certain places (e.g., office, school, home, public places such as restaurants, public transportation, airports, or tourist attractions, social meetings, etc.). For example, the portable computer determines if the current location is a first place (e.g., an office). If so, the portable computer calculates how frequently each program is used based on the usage statistics of the programs used at the first place for a fifth statistical period, and arranges the icons in order of most frequently used programs. Further, the portable computer is able to automatically recognize programs the user often uses at specific places, set the priorities of the programs, and arrange the icons in order of priority of the programs. Alternatively, the user can manually set the priorities of programs by place in a settings window, and the portable computer is able to arrange the icons according to the priorities of programs set by the user. A default value exists for the first place, and the first place can be changed by the user.

When arranging the icons according to the pattern of program use, the portable computer arranges the icons in order of programs the user often uses (or will most likely use) after running a specific program. For example, the portable computer determines if a first program is currently running. If so, the portable computer calculates how frequently each program is used based on the usage statistics of programs running after the first program is run, for a sixth statistical period, and arranges the icons in order of most frequently used programs. The portable computer is also able to automatically recognize the user's pattern of program use. Alternatively, the user can manually set the order of preferred programs in the settings window, and the portable computer is able to arrange the icons according to the order of preferred programs set by the user. A default value exists for the sixth statistical period, and the sixth statistical period can be changed by the user.

When arranging the icons by category, the portable computer classifies the programs by category to arrange the icons. For example, the portable computer identifies the category values for programs, and arranges the icons by categories corresponding to the program category values. A program category value may be categorization information about a certain program received from a program download server (e.g., an app store) when installing the program. Also, the user can arbitrarily determine the scope and definition of categories.

### 2. Method for Changing the Arrangement Criterion

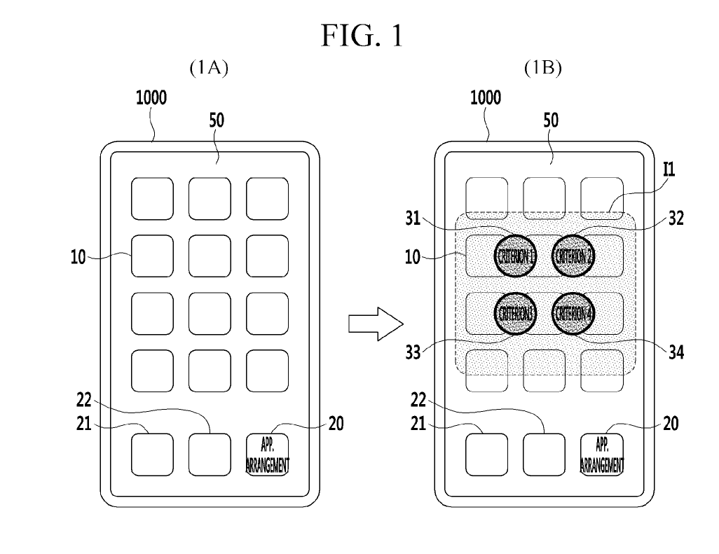

Referring to FIG. 1 to FIG. 3, a method for changing the arrangement criterion according to an exemplary embodiment of the present invention will be described.

FIG. 1 is a view showing a method for changing the criterion for icon arrangement according to an exemplary embodiment of the present invention. Particularly, FIG. 1 illustrates when the user manually changes the criterion for icon arrangement. FIG. 1 illustrates that a plurality of icons 10 and 20 to 22 are displayed on a screen 50 of a portable computer 1000.

As shown in 1A of FIG. 1, the portable computer 1000 displays the icon 20 of a program for changing the criterion for icon arrangement on the screen 50 of the portable computer 1000, and activates the icon 20 to run the arrangement criterion changing program if there is input (e.g. a touch) on the icon 20 from the user. As shown in 1B of FIG. 1, when the arrangement criterion changing program is run, an image I1 including a plurality of arrangement criteria 31 to 34 is displayed on the screen 50. The user chooses any one of the plurality of arrangement criteria 31 to 34, and the portable computer 1000 changes the criterion for icon arrangement to the arrangement criterion (e.g., 31) chosen by the user. Each of the arrangement criteria 31 to 34 may be at least one of the above-described criteria: most recently/frequently used, time, place, pattern of program use, and category.

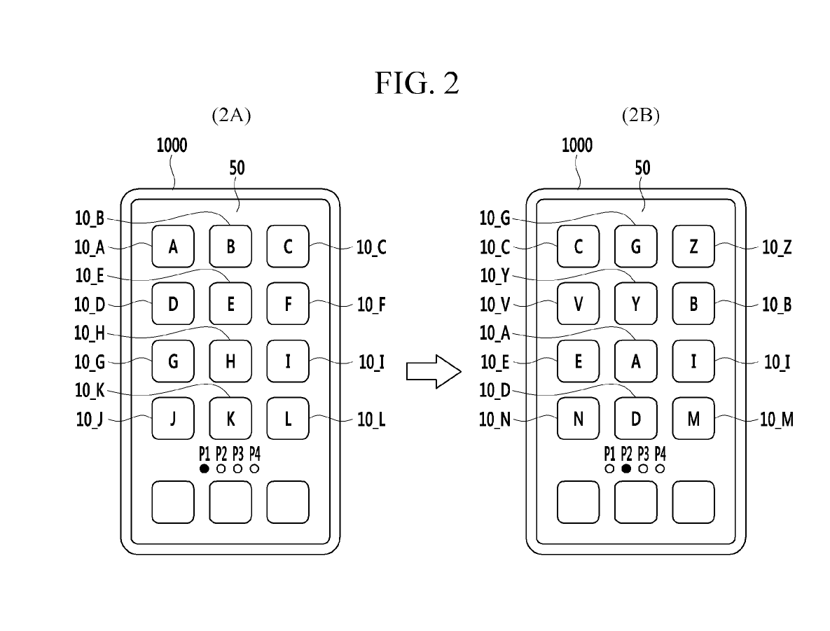

FIG. 2 is a view showing a method for changing the criterion for icon arrangement according to another exemplary embodiment of the present invention. Particularly, FIG. 2 illustrates when the user changes the criterion for icon arrangement manually (by flipping pages). That is, the user can change the criterion for icon arrangement through a gesture of moving from page to page on the screen.

2A of FIG. 2 illustrates a first screen page, and 2B of FIG. 2 illustrates a second screen page. The first screen page and the second screen page are pages where icons 10_A to 10_L, 10_N, 10_M, 10_V, 10_Y, and 10_Z are arranged according to different criteria and displayed on the screen 50 of the portable computer 1000. When a user gesture of vertically flipping pages (e.g., sliding the screen from a first point to a second point above the first point (or vice versa) on the standby screen) is input in the standby screen mode, the portable computer 1000 switches its operation mode to the arrangement criterion changing mode. The standby screen mode refers to a standby screen page being displayed on the screen 50, waiting for input from the user. If there is user input (a click, a touch, etc.) on a particular icon in the standby screen mode, the program corresponding to this icon is run. If the operation mode is the arrangement criterion changing mode, the portable computer 1000 displays the first screen page on the screen 50. When a user gesture of flipping pages sideways (e.g., sliding the screen from a third point to a fourth point on the left side of the third point (or vice versa)) is input on the screen 50 displaying the first screen page, the portable computer 1000 displays the second screen page on the screen 50. Page indicators P1 to P4 correspond to their own screen pages. Flipping pages to change the arrangement criterion can be done also vertically. The direction of page flipping for changing the arrangement criterion has a default value, which can be changed by the user.

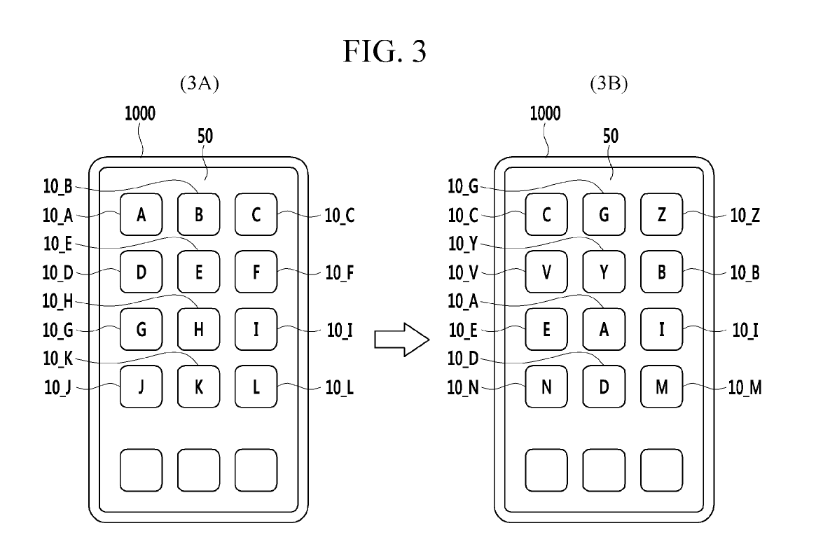

FIG. 3 is a view showing a method for changing the criterion for icon arrangement according to yet another exemplary embodiment of the present invention. Particularly, FIG. 3 illustrates when the portable computer 1000 automatically changes the criterion for icon arrangement.

More specifically, the portable computer 1000 is able to automatically change the criterion for icon arrangement according to time or place. When the criterion for icon arrangement is changed, the icons 10_A to 10_L arranged as shown in 3A of FIG. 3 are rearranged according to a new arrangement criterion, and the rearranged icons 10_A to 10_E, 10_G, 10_I, 10_N, 10_M, 10_V, 10_Y, and 10_Z are displayed on the screen 50 as shown in 3B of FIG. 3. The user can set the arrangement criterion for a specific time (and day and date) or a specific place in advance, and if it is determined that the current time corresponds to a specific time or the current location corresponds to a specific place, the portable computer 1000 is able to automatically change the criterion for icon arrangement to the arrangement criterion set by the user for the specific time or place. The portable computer 1000 automatically recognizes the user's favorite arrangement criterion for the specific time or place, based on statistical values, and if it is determined that the current time corresponds to a specific time or the current location corresponds to a specific place, the portable computer 1000 is able to automatically change the criterion for icon arrangement to the recognized arrangement criterion.

While the foregoing description has been given about selecting any one of a plurality of criteria for program icon arrangement, this is merely an example. The present invention may be designed such that, if two or more arrangement criteria are chosen from among a plurality of criteria for the arrangement of program icons, the icons can be arranged according to the chosen arrangement criteria.

### 3. Icon Display Method

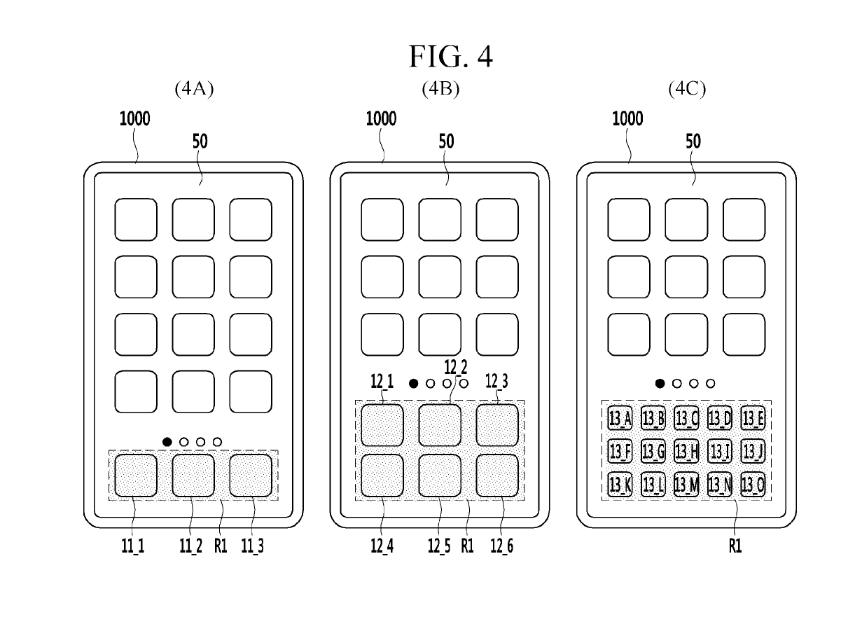

An icon display method according to an exemplary embodiment of the present invention will be described with reference to FIG. 4 to FIG. 7.

FIG. 4 is a view showing an icon display method according to an exemplary embodiment of the present invention. Particularly, FIG. 4 illustrates when all or some of icons arranged according to a criterion for icon arrangement are displayed in some space R1 of the screen 50. As shown in 4A of FIG. 4, the portable computer 1000 is able to allocate some space R1 of the standby screen and display all or some of the arranged icons 11_1 to 11_3 in the space R1 according to priority. A default value exists for the size of the space R1, and the size of the space R1 can be changed by the user. 4B of FIG. 4 illustrates when the space R1 is expanded. By expanding the space R1 as shown in 4B of FIG. 4, more icons 12_1 to 12_6 than those in 4A of FIG. 4 can be displayed in the space R1. Sizes restrictions for the space R1 can be eased by adjusting the size of icons 13_A to 13_O as shown in 4C of FIG. 4. A default value exists for the size of icons, and the size of icons can be changed by the user. The icons displayed in the space R1 may be icons that are arranged according to one arrangement criterion. Alternatively, the icons displayed in the space R1 may be icons that are arranged according to different criteria for different columns or rows.

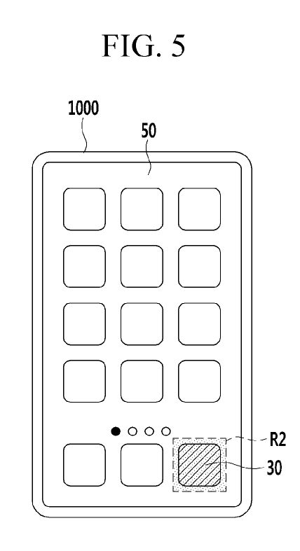

FIG. 5 is a view showing an icon display method according to another exemplary embodiment of the present invention. Particularly, FIG. 5 illustrates when icons arranged according to a criterion for icon arrangement are put into a folder 30 and the folder 30 is displayed in some space R2 of the screen 50. The portable computer 1000 is able to allocate some space R2 of the standby screen, put all or some of the arranged icons into the folder 30 according to priority, and display the folder 30 in the space R2. Alternatively, a plurality of folders may be displayed in the space R2, and the icons put into the plurality of folders may be icons that are arranged according to different arrangement criteria for the different folders.

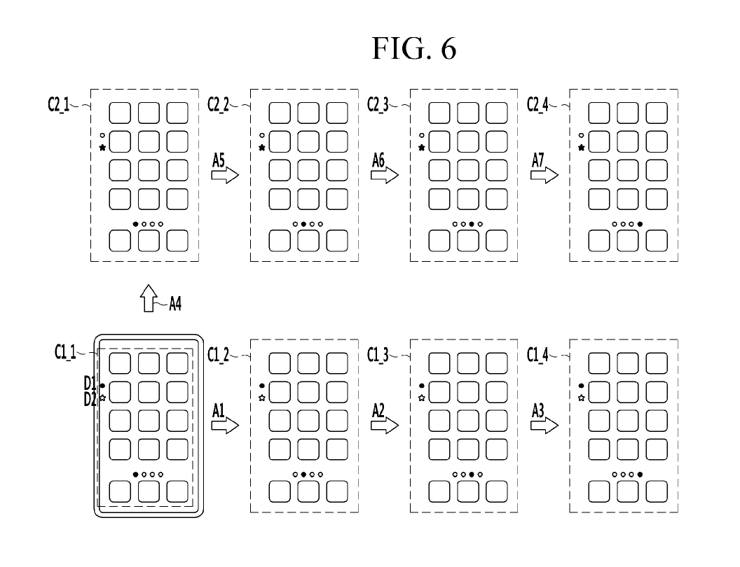

FIG. 6 is a view showing an icon display method according to yet another exemplary embodiment of the present invention. Particularly, FIG. 6 illustrates when all or some of the icons arranged according to a criterion for icon arrangement are displayed in a dual-layer structure. The portable computer 1000 is able to display the icons arranged according to different arrangement criteria for different icon layout pages C2_1 to C2_4 by flipping pages on the screen (e.g., by horizontally flipping pages on the screen A5 to A7). When a user gesture of vertically flipping pages A4 is input, with standby screen pages C1_1 to C1_4 being displayed on the screen 50, i.e., in the standby screen mode, the portable computer 1000 switches its operation mode to the arrangement criterion changing mode and moves to the icon layout pages C2_1 to C2_4. When a user gesture of horizontally flipping pages A5 to A7 is input in the arrangement criterion changing mode, the portable computer 1000 changes the criterion for icon arrangement to a different one, rearranges the icons according to the new criterion, and creates and displays icon layout pages C2_1 to C2_4 including all or some of the arranged icons. A mode indicator D1 corresponds to the standby screen mode, and a mode indicator D2 corresponds to the arrangement criterion changing mode. The standby screen pages C1_1- to C1_4 are pages that are displayed on the screen 50 in the standby screen mode by a user gesture of horizontally flipping pages A1 to A3. A default value exists for the sequence of the icon layout pages C2_1 to C2_4, and the sequence of the icon layout pages C2_1 to C2_4 can be changed by the user. Also, default values exist for the arrangement criteria for the icon layout pages C2_1 to C2_4, respectively, and the arrangement criteria for the icon layout pages C2_1 to C2_4 can be changed by the user.

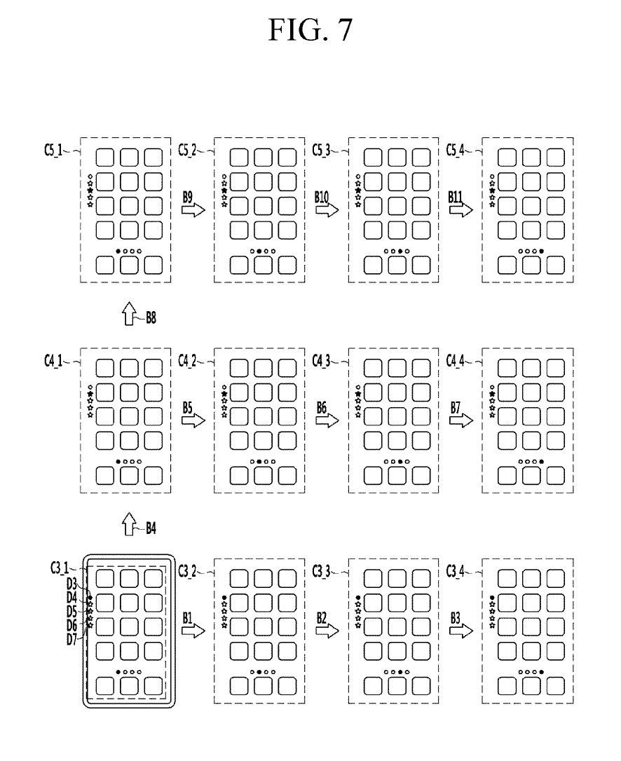

FIG. 7 is a view showing an icon display method according to a further exemplary embodiment of the present invention.

Particularly, FIG. 7 illustrates when all or some of the icons arranged according to a criterion for icon arrangement are displayed in a dual-layer structure. The portable computer 1000 is able to display the icons arranged according to different arrangement criteria for different icon layout pages C4_1 to C4_4 and C5_1 to C5_4 by flipping pages on the screen (e.g., by vertically flipping pages on the screen B4 and B8). When a user gesture of vertically flipping pages B4 is input, with standby screen pages C3_1 to C3_4 being displayed on the screen 50, i.e., in the standby screen mode, the portable computer 1000 switches its operation mode to the arrangement criterion changing mode and moves to the icon layout pages C4_1 to C4_4. The icon layout page C4_1 includes some of the icons arranged according to any one of a plurality of arrangement criteria. The same arrangement criterion is applied to each of the icon layout pages C4_1 to C4_4. When a user gesture of horizontally flipping pages B5 to B7 is input in the arrangement criterion changing mode, the icon layout pages C4_1 to C4_4 are each displayed on the screen 50. When a user gesture of vertically flipping pages B8 is input in the arrangement criterion changing mode, the portable computer 1000 changes the criterion for icon arrangement to a different one, rearranges the icons according to the new criterion, creates icon layout pages C5_1 to C5_4 including all or some of the arranged icons, and moves to the icon layout pages C5_1 to C5_4.

The same arrangement criterion is applied to each of the icon layout pages C5_1 to C5_4. When a user gesture of horizontally flipping pages B9 to B11 is input in the arrangement criterion changing mode, the icon layout pages C5_1 to C5_4 are each displayed on the screen 50. A mode indicator D3 corresponds to the standby screen mode, and mode indicators D4 to D7 correspond to the arrangement criterion changing mode. More specifically, the mode indicator D4 corresponds to the icon layout pages C4_1 to C4_4, and the mode indicator D5 corresponds to the icon layout pages C5_1 to C5_4. The standby screen pages C3_1 to C3_4 are pages that are displayed on the screen 50 in the standby screen mode by a user gesture of horizontally flipping pages B1 to B3. Default values exist for the sequence of the icon layout pages C4_1 to C4_4 and the sequence of the icon layout pages C5_1 to C5_4, and the sequence of the icon layout pages C4_1 to C4_4 and the sequence of the icon layout pages C5_1 to C5_4 can be changed by the user. Also, default values exist for the arrangement criteria for the icon layout pages C4_1 to C4_4 and C5_1 to C5_4, respectively, and the arrangement criteria for the icon layout pages C4_1 to C4_4 and C5_1 to C5_4 can be changed by the user.

### 4. Method of Managing Capacity of the Portable Computer 1000

The portable computer 1000 has limited storage space. Accordingly, it is necessary to manage the capacity of the portable computer 1000 because of a large number of programs and large-capacity programs. By managing the capacity of the portable computer 1000, the performance of the portable computer 1000 can be maximized, and the problem of having limited use of programs due to the limited storage space can be solved. Moreover, unnecessary programs which are periodically updated can be deleted by managing the capacity of the portable computer 100, thereby helping reduce wasted storage space. The portable computer 1000 allows the user to easily identify unnecessary programs so that the user can delete these programs or these programs can be automatically deleted. The method of managing the capacity of the portable computer 1000 may be the method of notification of unnecessary programs, the display method using a temporary storage box, or the automatic program deletion method.

The method of notification of unnecessary programs will be described first. The portable computer 1000 distinguishes programs that are not used often for a seventh statistical period among the installed programs. For example, the portable computer 1000 determines if there are programs that have been used less than a threshold for the seventh statistical period among the installed programs. The threshold may be set to have a different value according to program category.

For example, the threshold for a first program category (e.g., game programs) may be set to a first value (e.g., 2), and the threshold value for a second program category (e.g., news programs) may be set to a second value (e.g., 5). Also, the portable computer 1000 notifies the user of programs that are not used often. More specifically, the portable computer 1000 is able to display the icons of programs that are not used often on the screen 50 by a similar method to the above-described 3) icon display method. The user becomes aware of the presence of unnecessary programs through the unnecessary programs' icons displayed on the screen 50, and can select and delete these programs.

Next, the display method using a temporary storage box (e.g., the recycle bin) will be described. The portable computer 1000 distinguishes programs that are not used often for the seventh statistical period among installed programs, and stores the icons of these programs in a temporary storage box. If there is no response on the icons stored in the temporary storage box (e.g., an instruction to delete the icons from the temporary storage box) for a threshold period of time, the portable computer 1000 arbitrarily deletes the programs corresponding to the icons stored in the temporary storage box. The threshold period of time can be changed by the user, and the arbitrary delete function can be switched on/off by the user. The user's response on the icons stored in the temporary storage box can be reflected in the function for distinguishing unnecessary programs.

Next, the automatic program deletion method will be described. The portable computer 1000 distinguishes programs that are not used often for the seventh statistical period among installed programs, and automatically deletes these programs. The portable computer 1000 is able to automatically delete programs based on delete settings information. The delete settings information is information about a program category (e.g., game program category) that the user permits to be automatically deleted, and can be changed by the user.

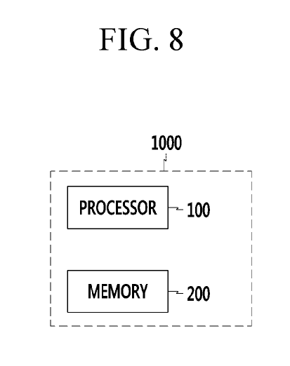

FIG. 8 is a view showing the configuration of a portable computer 1000 according to an exemplary embodiment of the present invention.

The portable computer 1000 includes a processor 100 and a memory 200.

The processor 100 manages programs installed in the memory 200 and their icons.

The processor 100 can be configured to implement the functions, operations, and methods explained with respect to the above-described 1) criteria for icon arrangement, 2) method for changing the criterion for icon arrangement, 3) an icon display method, and 4) method of managing the capacity of the portable computer 1000.

Conventionally, it has not been easy for the user to access a desired program among many programs installed within a portable computer according to circumstances. However, the present invention allows the portable computer to observe the user's behavior or pattern of program use and the order of programs preferred by the user in association with criteria including most recently/frequently used, time (or day, date, or special occasion), place, etc., set the priorities of programs according to arrangement criteria, and display the program icons. By doing so, the user can easily access a required program (or a program the user will highly likely access) according to circumstances (e.g., a specific time of day, a specific place, etc.) and use this program.

According to an embodiment of the present invention, the portable computer notifies the user of unnecessary programs so that the user can easily identify them, thus helping the user to manage the capacity of the portable computer with ease.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for managing icons of programs installed in a terminal, the method comprising:
determining a criterion for icon arrangement;
arranging the icons according to the criterion for icon arrangement; and
displaying all or some of the arranged icons on a screen,
wherein the criterion for icon arrangement comprises at least one of most recently/frequently used, time, place, pattern of program use, and category.

2. The method of claim 1, wherein
the arranging comprises:
when arranging the icons by most frequently used, calculating how frequently each program is used based on usage statistics of the programs used for a statistical period; and
arranging the icons in order of most frequently used programs.

3. The method of claim 1, wherein
the arranging comprises:
when arranging the icons by time, determining whether a current time is within a first time range;
if so, calculating how frequently each program is used based on usage statistics of the programs used within the first time range for a statistical period; and
arranging the icons in order of most frequently used programs.

4. The method of claim 1, wherein
the arranging comprises:
when arranging the icons by time, determining whether a current day is a first day;
if so, calculating how frequently each program is used based on usage statistics of the programs used on first days for a statistical period; and
arranging the icons in order of most frequently used programs.

5. The method of claim 1, wherein
the arranging comprises:
when arranging the icons by time, determining whether a current date is a first date;
if so, calculating how frequently each program is used based on usage statistics of the programs used on first dates for a statistical period; and
arranging the icons in order of most frequently used programs.

6. The method of claim 1, wherein
the arranging comprises:
when arranging the icons by place, determining whether a current location is a first place;
if so, calculating how frequently each program is used based on usage statistics of the programs used at the first place for a statistical period; and
arranging the icons in order of most frequently used programs.

7. The method of claim 1, wherein
the arranging comprises:
when arranging the icons according to the pattern of program use, determining whether a first program is currently running;
if so, calculating how frequently each program is used based on usage statistics of programs running after the first program is run, for a statistical period; and
arranging the icons in order of most frequently used programs.

8. The method of claim 1, wherein
the arranging comprises:
when arranging the icons by category, identifying category values for the programs; and
arranging the icons by categories corresponding to the program category values.

9. The method of claim 1, further comprising, before the determining, changing the criterion for icon arrangement to a first arrangement criterion of a plurality of arrangement criteria,
wherein the first arrangement criterion comprises at least one of the above-described criteria, which are most recently/frequently used, time, place, pattern of program use, and category.

10. The method of claim 9, wherein
the changing comprises:
displaying a first icon corresponding to a first program for changing the criterion for icon arrangement, on the screen;
when there is user input on the first icon, running the first program and displaying the plurality of arrangement criteria on the screen; and
when there is user input on the first arrangement criterion, changing the criterion for icon arrangement to the first arrangement criterion.

11. The method of claim 9, wherein
the changing comprises:
when there is user input of sliding the screen from a first point to a second point on the screen, displaying a first page for changing the criterion for icon arrangement on the screen; and
when there is user input of sliding a first screen from a third point to a fourth point on the first screen displaying the first page, changing the criterion for icon arrangement to the first arrangement criterion.

12. The method of claim 9, wherein
the changing comprises:
determining whether at least either one of the current time and the current location corresponds to change settings information; and
if so, changing the criterion for icon arrangement to the first arrangement criterion according to the change settings information.

13. The method of claim 1, wherein
the displaying comprises:
allocating a first portion of the screen as a space for displaying the arranged icons; and
displaying all or some of the icons arranged in the first portion.

14. The method of claim 11, further comprising, when there is user input of sliding a second screen from a fifth point to a sixth point, with the second screen displaying all or some of the icons arranged according to the first arrangement criterion, changing the criterion for icon arrangement to a second arrangement criterion of the plurality of arrangement criteria.

15. The method of claim 14, wherein
the first point is above or below the second point,
the third point is on the left or right side of the fourth point, and
the fifth point is on the left or right side of the sixth point.

16. The method of claim 14, wherein
the first point is above or below the second point,
the third point is above or below the fourth point, and
the fifth point is above or below the sixth point

17. A terminal comprising:
a memory; and
a processor for managing icons of programs installed in the memory,
wherein the processor determines a criterion for icon arrangement, arranges the icons according to the criterion for icon arrangement, and displays all or some of the arranged icons on a screen, and
the criterion for icon arrangement comprises at least one of most recently/frequently used, time, place, pattern of program use, and category.

18. A terminal comprising:
a memory; and
a processor for managing icons of programs installed in the memory,
wherein the processor determines whether there is a first program that have been used less than a threshold for a statistical period among the programs.

19. The terminal of claim 18, wherein the processor determines whether the first program is deletable based on delete settings information set by the user, and if so, deletes the first program.

20. The terminal of claim 18, wherein the processor stores a first icon corresponding to the first program in a temporary storage box, and deletes the first program when no instruction to delete the first icon from the temporary storage box is input from the user for a threshold period of time.
